(19) United States
(12) Patent Application Publication
(10) Pub. No.: US 2012/0074727 A1
(43) Pub. Date: Mar. 29, 2012

(54) Car gas tank substitute door

(76) Inventor: Richard Calvin Poole, Highland Park, MI (US)

(21) Appl. No.: 12/924,439

(22) Filed: Sep. 27, 2010

(51) Int. Cl. B60K 15/05

(52) U.S. Cl. 296/97.22

(57) ABSTRACT

The Car Gas Tank Substitute Door is a component that is connected to the other side of the gas tank, that will be utilize as a substitute gas panel door

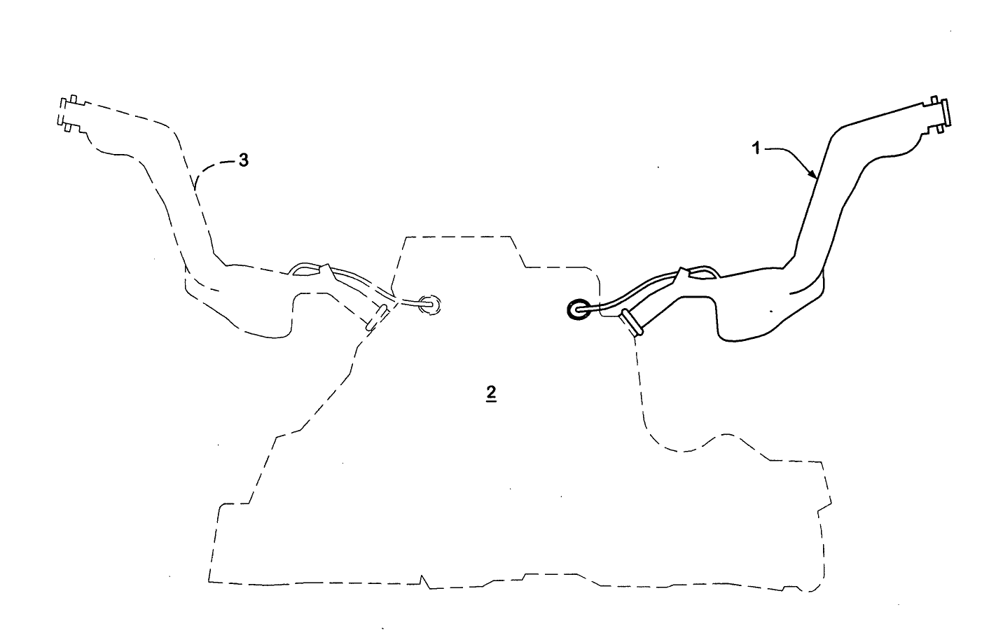

### CROSS REFERENCE TO RELATED APPLICATIONS

“Not Applicable”

### STATEMENT OF FEDERALLY SPONSORED RESEARCH/DEVELOPMENT

“Not Applicable”

### REFERENCE TO A “SEQUENCE LISTING,” A TABLE, OR A COMPUTER PROGRAM LISTING APPENDIX SUBMITTED ON A COMPACT DISC

“Not Applicable”

### BACKGROUND OF THE INVENTION

Every time I pull up to a gas station to put gas in my car, there always two or three cars in front of me at the gas pump. When I see a gas pump not being utilize on the other side of the gas pump station, that is on the same side of my gas panel door, when I turn my car around to get on the other side, someone beat me to it. I came up with this concept, why not put another gas panel door on the other side of the vehicle it would be very convenience for the drivers. Instead of waiting for the other drivers, who are in front of you, with another gas panel door on the other side of the car, the drivers can go to the gas pump across from them.

### BRIEF SUMMARY OF THE INVENTION

My invention, will not only be convenience for the drivers, but efficient as well.

### BRIEF DESCRIPTION OF THE SEVERAL VIEWS OF THE DRAWING

There is only one view on this drawing. The first description is number 1: the substitute fuel tank filler neck, number two: gas tank and number three: the original fuel tank filler neck

### DETAILED DESCRIPTION OF THE INVENTION

The car gas tank substitute door is another fuel tank filler neck that will be on a car or truck. The long tubular part will connect on the other side of the gas tank. With another gas cap on the other side of the vehicle.

### SEQUENCE LISTING

“Not Applicable”

What I claim as my invention is:

1. “The Car Gas Tank Substitute Door”
